(19) United States
(12) Patent Application Publication
(10) Pub. No.: US 2024/0370703 A1
(43) Pub. Date: Nov. 7, 2024

(54) CONTEXT-AWARE LANGUAGE MODELS

(71) Applicant: VIANAI SYSTEMS, INC., Palo Alto, CA (US)

(72) Inventors: Vishal Inder SIKKA, Los Altos Hills, CA (US); Navin BUDHIRAJA, Palo Alto, CA (US)

(21) Appl. No.: 18/655,187

(22) Filed: May 3, 2024

Related U.S. Application Data
(60) Provisional application No. 63/499,908, filed on May 3, 2023.

(51) Int. Cl. G06N 3/0455; G06F 40/284; G06F 40/40

(52) U.S. Cl. CPC G06N 3/0455; G06F 40/284; G06F 40/40

(57) ABSTRACT

One embodiment of the present invention sets forth a technique for computer-implemented method for training a machine learning model includes appending context information to at least one portion of first data to generate second data, and performing one or more operations to train the machine learning model based on the second data to generate a trained machine learning model.

### CROSS-REFERENCE TO RELATED APPLICATIONS

This application claims benefit of the United States Provisional patent application titled “CONTEXT-AWARE LANGUAGE MODELS,” filed May 3, 2023, and having Ser. No. 63/499,908. The subject matter of this related application is hereby incorporated herein by reference.

### BACKGROUND

### Field of the Various Embodiments

Embodiments of the present disclosure relate generally to computer science, artificial intelligence (AI), and machine learning and, more specifically, to context-aware language models.

### Description of the Related Art

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. In turn, the information output by a trained machine learning model can be used to guide decisions and/or perform actions related to new data.

Language models, such as large language models (LLMs), are one type of machine learning model that have become increasingly capable of performing various natural language processing tasks. Conventionally, a language model is implemented as a neural network that can be trained on a large quantity of text data. Once trained, a language model can oftentimes perform a wide variety of natural language processing tasks, such as answering questions, performing sentiment analysis, and performing entity recognition.

One drawback of conventional language models is that these models sometimes generate outputs that are incorrect. Incorrect outputs generated by language models are also sometimes referred to as “hallucinations.” For example, when prompted to answer a question, a conventional language model can sometimes generate an answer that is factually inaccurate. Currently, there are few, if any, good ways to check the accuracy of the outputs generated by conventional language models.

As the foregoing illustrates, what is needed in the art are more effective techniques for understanding the accuracy of the outputs generated by language models

### SUMMARY

One embodiment of the present disclosure sets forth a computer-implemented method for training a machine learning model. The method includes appending context information to at least one portion of first data to generate second data. The method further includes performing one or more operations to train the machine learning model based on the second data to generate a trained machine learning model.

Another embodiment of the present disclosure sets forth a computer-implemented method for verifying responses to requests. The method includes processing a first request via a trained machine learning model to generate a first response. The method further includes performing one or more operations to verify the first response based on first data used to train the trained machine learning model.

Other embodiments of the present disclosure include, without limitation, one or more computer-readable media including instructions for performing one or more aspects of the disclosed techniques as well as one or more computing systems for performing one or more aspects of the disclosed techniques.

One technical advantage of the disclosed techniques relative to the prior art is that the disclosed techniques train machine learning models to learn the context(s) associated with training data, such as text data that is used to train language models. Once trained, the machine learning models can output not only a response to a given request, but also the context associated with that response. Another advantage is that, with the disclosed techniques, responses generated by a machine learning model can be verified against data used to train the machine learning model. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 is a more detailed illustration of the model trainer of FIG. 1, according to various embodiments;

FIG. 5 is a more detailed illustration of the natural language application of FIG. 1, according to various embodiments;

FIG. 6 is a flow diagram of method steps for training a language model, according to various embodiments; and

FIG. 7 is a flow diagram of method steps for processing a user request using a trained language model, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

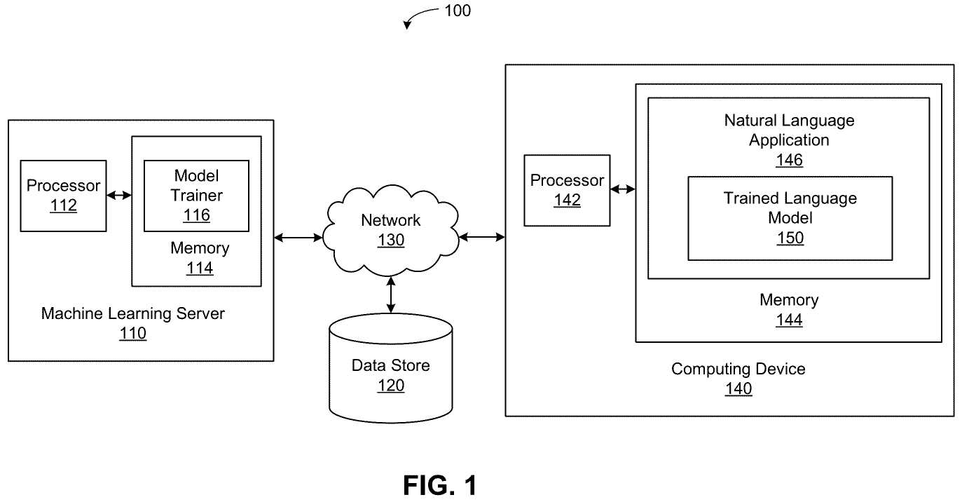

FIG. 1 illustrates a system 100 configured to implement one or more aspects of the various embodiments. As shown, the system 100 includes a machine learning server 110, a data store 120, and a computing device 140 in communication over a network 130, which may be a wide area network (WAN) such as the Internet, a local area network (LAN), or any other suitable network.

As shown, a model trainer 116 executes on a processor 112 of the machine learning server 110 and is stored in a memory 114 of the machine learning server 110. The processor 112 receives user input from input devices, such as a keyboard, a mouse, a joystick, a touchpad, or a touchscreen. In operation, the processor 112 is the master processor of the machine learning server 110, controlling and coordinating operations of other system components. In particular, the processor 112 may issue commands that control the operation of a graphics processing unit (GPU) that incorporates circuitry optimized for graphics and video processing, including, for example, video output circuitry. The GPU may deliver pixels to a display device that may be any conventional cathode ray tube, liquid crystal display, light-emitting diode display, or the like.

The memory 114 of the machine learning server 110 stores content, such as software applications and data, for use by the processor 112 and the GPU. The memory 114 may be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) may supplement or replace the memory 114. The storage may include any number and type of external memories that are accessible to the processor 112 and/or the GPU. For example, and without limitation, the storage may include a Secure Digital Card, an external Flash memory, a portable compact disc read-only memory (CD-ROM), an optical storage device, a magnetic storage device, or any suitable combination of the foregoing.

It will be appreciated that the machine learning server 110 shown herein is illustrative and that variations and modifications are possible. For example, the number of processors 112, the number of GPUs, the number of system memories 114, and the number of applications included in the memory 114 may be modified as desired. Further, the connection topology between the various units in FIG. 1 may be modified as desired. In some embodiments, any combination of the processor 112, the memory 114, and a GPU may be replaced with any type of virtual computing system, distributed computing system, or cloud computing environment, such as a public, private, or a hybrid cloud.

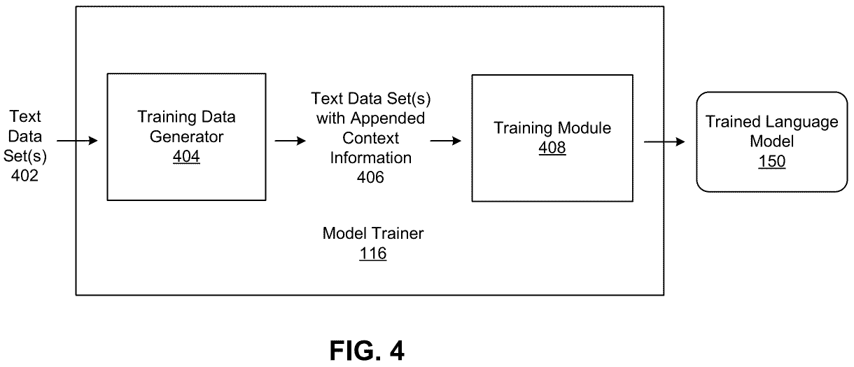

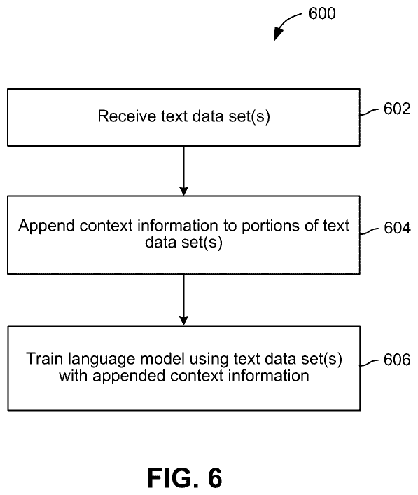

As discussed in greater detail below, the model trainer 116 is configured to generate training data and train machine learning models, such as language model 150, using the training data. Techniques that model trainer 116 can employ to generate training data and train machine learning models are described in greater detail below in conjunction with FIGS. 4 and 6.

Training data and/or models, including the trained language model 150, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in some embodiments the machine learning server 110 may include the data store 120.

Trained machine learning models, such as the trained language model 150, can be deployed to any suitable applications in some embodiments. Illustratively, a natural language application 146 that utilizes the trained language model 150 is stored in a memory 144, and executes on a processor 142, of the computing device 140. In some embodiments, the natural language application 146 can be an application that performs any technically feasible natural language processing tasks using the trained language model 150, such as such as answering questions, performing sentiment analysis, performing entity recognition, generating program code, and/or the like. Components of the computing device 140, including the memory 144 and the processor 142, may be similar to corresponding components of the machine learning server 110 in some embodiments.

The number of machine learning servers and computing devices may be modified as desired. Further, the functionality included in any of the applications may be divided across any number of applications or other software that are stored and executed via any number of devices that are located in any number of physical locations.

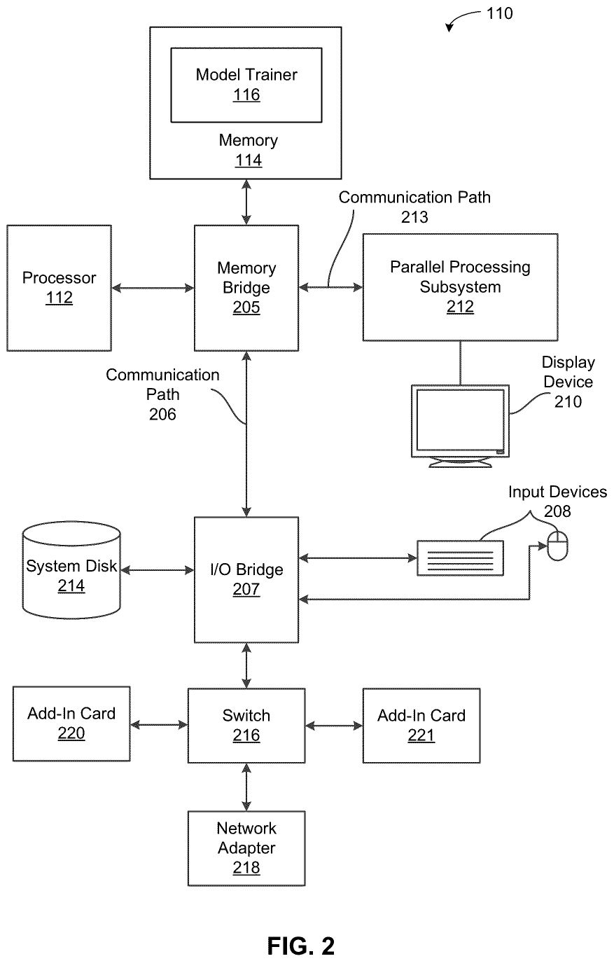

FIG. 2 is a more detailed illustration of the machine learning server 110 of FIG. 1, according to various embodiments. As persons skilled in the art will appreciate, the machine learning server 110 can be any type of technically feasible computer system, including, without limitation, a server machine, a server platform, a desktop machine, laptop machine, a hand-held/mobile device, or a wearable device. In some embodiments, the machine learning server 110 is a server machine operating in a data center or a cloud computing environment that provides scalable computing resources as a service over a network.

In various embodiments, the machine learning server 110 includes, without limitation, the processor 112 and the memory 114 coupled to a parallel processing subsystem 212 via a memory bridge 205 and a communication path 213. The memory bridge 205 is further coupled to an I/O (input/output) bridge 207 via a communication path 206, and the I/O bridge 207 is, in turn, coupled to a switch 216.

In some embodiments, the I/O bridge 207 is configured to receive user input information from optional input devices 208, such as a keyboard or a mouse, and forward the input information to the processor 112 for processing via the communication path 206 and the memory bridge 205. In some embodiments, the machine learning server 110 may be a server machine in a cloud computing environment. In such embodiments, the machine learning server 110 may not have input devices 208. Instead, the machine learning server 110 may receive equivalent input information by receiving commands in the form of messages transmitted over a network and received via the network adapter 218. In some embodiments, the switch 216 is configured to provide connections between the I/O bridge 207 and other components of the machine learning server 110, such as a network adapter 218 and various add-in cards 220 and 221.

In some embodiments, the I/O bridge 207 is coupled to a system disk 214 that may be configured to store content and applications and data for use by the processor 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, communication paths 206 and 213, as well as other communication paths within the machine learning server 110, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. Such circuitry may be incorporated across one or more parallel processing units (PPUs), also referred to herein as parallel processors, included within the parallel processing subsystem 212. In other embodiments, the parallel processing subsystem 212 incorporates circuitry optimized for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and compute processing operations. The system memory 114 includes at least one device driver configured to manage the processing operations of the one or more PPUs within the parallel processing subsystem 212. In addition, the system memory 114 includes the model trainer 116. Although described herein primarily with respect to the model trainer 116, techniques disclosed herein can also be implemented, either entirely or in part, in other software and/or hardware, such as in the parallel processing subsystem 212.

In various embodiments, the parallel processing subsystem 212 may be integrated with one or more of the other elements of FIG. 2 to form a single system. For example, the parallel processing subsystem 212 may be integrated with the processor 112 and other connection circuitry on a single chip to form a system on chip (SoC).

In some embodiments, the processor 112 is the master processor of the machine learning server 110, controlling and coordinating operations of other system components. In some embodiments, the processor 112 issues commands that control the operation of PPUs. In some embodiments, the communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, the system memory 114 could be connected to processor 112 directly rather than through the memory bridge 205, and other devices would communicate with system memory 114 via the memory bridge 205 and the processor 112. In other embodiments, the parallel processing subsystem 212 may be connected to the I/O bridge 207 or directly to the processor 112, rather than to the memory bridge 205. In still other embodiments, the I/O bridge 207 and the memory bridge 205 may be integrated into a single chip instead of existing as one or more discrete devices. In certain embodiments, one or more components shown in FIG. 2 may not be present. For example, the switch 216 could be eliminated, and the network adapter 218 and the add-in cards 220, 221 would connect directly to the I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 could be implemented as a virtual graphics processing unit (GPU) that renders graphics on a virtual machine (VM) executing on a server machine whose GPU and other physical resources are shared across multiple VMs.

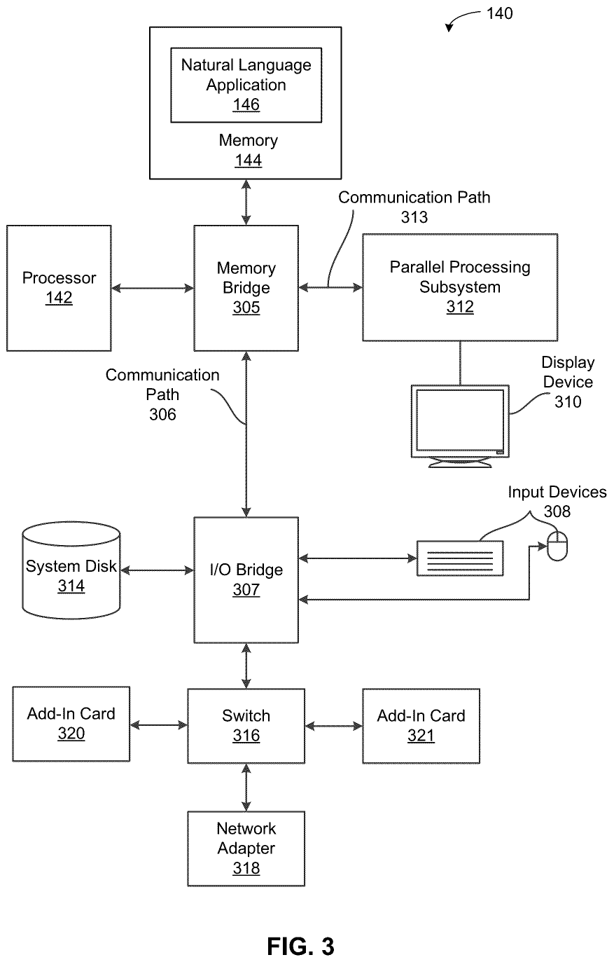

FIG. 3 illustrates in greater detail the computing device 140 of FIG. 1, according to various embodiments. As persons skilled in the art will appreciate, the computing device 140 can be any type of technically feasible computer system, including, without limitation, a server machine, a server platform, a desktop machine, laptop machine, a hand-held/mobile device, or a wearable device. In some embodiments, the computing device 140 is a server machine operating in a data center or a cloud computing environment that provides scalable computing resources as a service over a network.

In various embodiments, the computing device 140 includes, without limitation, the processor 142 and the memory 144 coupled to a parallel processing subsystem 312 via a memory bridge 305 and a communication path 313. The memory bridge 305 is further coupled to an I/O (input/output) bridge 307 via a communication path 306, and the I/O bridge 307 is, in turn, coupled to a switch 316.

In some embodiments, the I/O bridge 307 is configured to receive user input information from optional input devices 308, such as a keyboard or a mouse, and forward the input information to the processor 142 for processing via the communication path 306 and the memory bridge 305. In some embodiments, the computing device 140 may be a server machine in a cloud computing environment. In such embodiments, the computing device 140 may not have input devices 308. Instead, the computing device 140 may receive equivalent input information by receiving commands in the form of messages transmitted over a network and received via the network adapter 318. In some embodiments, the switch 316 is configured to provide connections between the I/O bridge 307 and other components of the computing device 140, such as a network adapter 318 and various add-in cards 320 and 321.

In some embodiments, the I/O bridge 307 is coupled to a system disk 314 that may be configured to store content and applications and data for use by the processor 142 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to the I/O bridge 307 as well.

In various embodiments, the memory bridge 305 may be a Northbridge chip, and the I/O bridge 307 may be a Southbridge chip. In addition, communication paths 306 and 313, as well as other communication paths within the computing device 140, may be implemented using any technically suitable protocols, including, without limitation, AGP (Accelerated Graphics Port), HyperTransport, or any other bus or point-to-point communication protocol known in the art.

In some embodiments, the parallel processing subsystem 312 comprises a graphics subsystem that delivers pixels to an optional display device 310 that may be any conventional cathode ray tube, liquid crystal display, light-emitting diode display, or the like. In such embodiments, the parallel processing subsystem 312 incorporates circuitry optimized for graphics and video processing, including, for example, video output circuitry. Such circuitry may be incorporated across one or more parallel processing units (PPUs), also referred to herein as parallel processors, included within the parallel processing subsystem 312. In other embodiments, the parallel processing subsystem 312 incorporates circuitry optimized for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and compute processing operations. The system memory 144 includes at least one device driver configured to manage the processing operations of the one or more PPUs within the parallel processing subsystem 312. In addition, the system memory 144 includes the natural language application 146. Although described herein primarily with respect to the natural language application 146, techniques disclosed herein can also be implemented, either entirely or in part, in other software and/or hardware, such as in the parallel processing subsystem 312.

In various embodiments, the parallel processing subsystem 312 may be integrated with one or more of the other elements of FIG. 3 to form a single system. For example, the parallel processing subsystem 312 may be integrated with the processor 142 and other connection circuitry on a single chip to form a system on chip (SoC).

In some embodiments, the processor 142 is the master processor of the computing device 140, controlling and coordinating operations of other system components. In some embodiments, the processor 142 issues commands that control the operation of PPUs. In some embodiments, the communication path 313 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 302, and the number of parallel processing subsystems 312, may be modified as desired. For example, in some embodiments, the system memory 144 could be connected to processor 142 directly rather than through the memory bridge 305, and other devices would communicate with system memory 144 via the memory bridge 305 and the processor 142. In other embodiments, the parallel processing subsystem 312 may be connected to the I/O bridge 307 or directly to the processor 142, rather than to the memory bridge 305. In still other embodiments, the I/O bridge 307 and the memory bridge 305 may be integrated into a single chip instead of existing as one or more discrete devices. In certain embodiments, one or more components shown in FIG. 3 may not be present. For example, the switch 316 could be eliminated, and the network adapter 318 and the add-in cards 320, 321 would connect directly to the I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in some embodiments. For example, the parallel processing subsystem 312 could be implemented as a virtual graphics processing unit (GPU) that renders graphics on a virtual machine (VM) executing on a server machine whose GPU and other physical resources are shared across multiple VMs.

### Context-Aware Language Models

FIG. 4 is a more detailed illustration of the model trainer 116 of FIG. 1, according to various embodiments. As shown, the model trainer 116 includes a training data generator 404 and a training module 408. In operation, the model trainer 116 receives one or more text data sets 402 as input, and the model trainer 116 uses the text data set(s) 402 to train the language model 150. In some embodiments, any suitable text data set(s), such as the common crawl, books, newspapers, journal articles, code libraries, and/or the like can be received by the model trainer 116. Although described herein primarily with respect to using text data to train language models as a reference example, in some embodiments, techniques disclosed herein can be used to train, and verify the outputs generated by, any suitable machine learning models.

Given the text data set(s) 402 as input, a training data generator 404 processes the text data set(s) 402 to generate text data set(s) with context information 406 that is appended to portions of the text data set(s) 402. In some embodiments, the appended context information can indicate data sources, including the text data set(s) as well as higher level contexts, if any, from which the portions of the text data set(s) originate. For example, when the text data set(s) include a number of books, context information could be appended to each sentence within a given book to indicate that the sentence originated from the given book and any higher level contexts, such a collection or genre of books to which the given book belongs. In some embodiments, training data generator 404 appends context information to each of a number of portions of the text data set(s) 402 to generate the text data set(s) with appended context information 406. For example, in some embodiments, the portions of the text data set(s) 402 can be sentences, and the training data generator 404 can append context information to the end of each sentence. In such cases, the context information that is appended to the end of each sentence can include one or more tokens indicating one or more contexts associated with the sentence. For example, the token(s) could be one or more numbers identifying the one or more contexts. Alternatively, in such cases, the context information that is appended to each sentence can indicate a hierarchy of one or more contexts associated with the sentence. For example, the hierarchy could be stored in a separate data structure, and the context information can include the separate data structure or a pointer to the separate data structure.

In some embodiments, contexts can be organized in any suitable manner, including as one or more hierarchies. An example of a context hierarchy is a books context having a fictional books sub-context and a nonfictional books sub-context. Another example context hierarchy is an article context having a section sub-context, and the section sub-context having a sub-section sub-context. Yet another context example hierarchy is a book repository (e.g., a digital library) context having a book collection (e.g., a particular encyclopedia) sub-context, and the book collection sub-context having a book volume (e.g., a particular volume of the encyclopedia) sub-context. A response generated by the language model 150 can be true in one or more of the contexts in a hierarchy of contexts. For example, a response that time travel is possible can be true in the fictional books sub-context but not the nonfictional books sub-context or the overall books context. In some embodiments, an application (e.g., natural language application 146) that uses the language model 150 can include a function that accounts for certain answers that the language model 150 indicates is only true in the context that a user selects. As another example, a response that the Empire State Building is the tallest building in the world can be true in the context of nonfictional books within a certain time period, and the language model 150 can be trained using text data set(s) having appended context information that indicates such contexts so that the trained language model 150 is able to output the contexts in which generated responses are true. In some embodiments, certain contexts can be allowed to collide with other contexts, and certain contexts may not be allowed to collide with other contexts. It should be understood that certain predicates can be true of the language model 150. For example, the predicate “is true” context c and proposition p can indicate whether proposition p is true in the context of context c. Examples of other relations include partially true, not false, probability of being true, degree of being true, truth value, values of certain things (e.g., the height of a building can be different in different units within different contexts), time, and the like.

Subsequent to generation of the text data set(s) with appended context information 406, the training module 408 trains a language model using the text data set(s) with appended context information 406 to generate the trained language model 150. In some embodiments, the language model can either be trained from scratch or fine-tuned from a previously trained language model. In some embodiments, the language model can be trained to reproduce each portion of the text data set(s) with appended context information 406, such as each sentence that ends with a token indicating an associated context or a hierarchy of associated contexts, on a token-by-token basis, until the language model is able to reproduce the portion of the text data set(s) and the associated context or the hierarchy of associated contexts, and the training then proceeds to a next portion (e.g., a next sentence) of the text data set(s) with appended context information 406. In some embodiments, the language model can be trained to generate a response while ignoring the context, but add context information at the end of the response.

In some embodiments, the trained language model 150 can have any technically feasible architecture. For example, in some embodiments, the trained language model 150 can be an artificial neural network, such as a large language model (LLM), that includes one or more connected neurons and/or layer(s) thereof that store the relationships between information from training data and one or more contexts that are associated with such information. As another example, in some embodiments, the language model 150 can include multiple artificial neural networks, such as multiple LLMs, that are each trained using information associated with a different context. In such cases, the language model 150 can also include another model that combines outputs of the multiple language models to generate a final output and indicates context(s) associated with the final output.

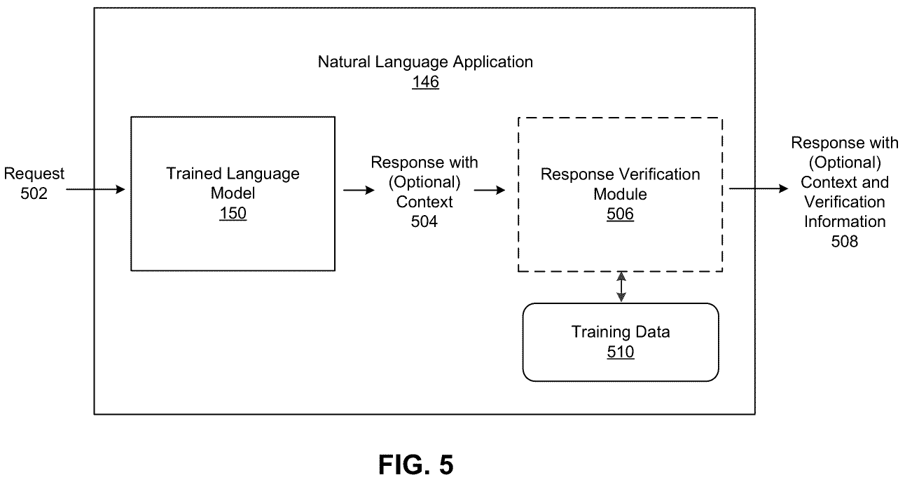

FIG. 5 is a more detailed illustration of the natural language application 146 of FIG. 1, according to various embodiments. As shown, the natural language application 146 includes a trained language model 150, a response verification module 506, and training data 510. Although the trained language model 150 and the training data 510 are shown as being included in the natural language application 146 for illustrative purposes, in some embodiments, the trained language model 150 and/or the training data 510 can be external to the natural language application 146. For example, the trained language model 150 could execute in a cloud computing environment and be accessed by the natural language application 146 via an application programming interface (API). As another example, the training data 510 could be stored in an external data store (e.g., data store 120).

In operation, the natural language application 146 receives as input a request 502 from a user. In some embodiments, the request can include any suitable text data, such as a natural language question, that is capable of being processed using the trained language model 150. Given the request 502, the natural language application 146 inputs the request 502 into the trained language model 150 to generate a response and optionally context information associated with the response 504. The context information can be output if the language model 150 is trained to output such information, as described above in conjunction with FIG. 4. Alternatively, in some embodiments, a trained language model may not output any context information if the language model is not trained to output such information. In some embodiments, the natural language application 146 can also perform any technically feasible processing of the request 502 prior to inputting the processed results into the trained language model 150.

Subsequent to the training described above in conjunction with FIG. 4, the trained language model 150 is capable of responding to user requests and also providing context information associated with the responses. For example, in some embodiments, when the language model 150 is trained using sentences that end with tokens indicating the context associated with the sentences, then the language model 150 can append a token indicating the context to the end of a response. As another example, in some embodiments, when the language model 150 is trained using sentences that end with indications of hierarchies of associated contexts, then the language model 150 can append an indication of a context hierarchy that is associated with a response to the end of the response.

Illustratively, the response and optional context information 504 are optionally input into a response verification module 506. Alternatively, in some embodiments, a response and associated context information can be directly output by the natural language application 146, without verification. As shown, the response verification module 506 processes the response and optional context information 504 using one or more verification techniques and training data 510 that was used to train the language model 150 to generate verification information. Then, the natural language application 146 generates an output 508 that includes the response with the optional context information and the verification information.

In some embodiments, the verification technique(s) can include computing a similarity (e.g., Cosine similarity) between an embedding of the response with embedding(s) generated based on training data, such as the text data set(s) 402, used to train the language model 150. For example, in some embodiments, the verification technique(s) can include computing such similarities to perform an embedding search of one or more contexts (e.g., all contexts in a context hierarchy) included in the training data to determine verification information that indicates which context is closest to the response, the degree of similarity of the response to each of the one or more contexts, and/or the like.

In some embodiments, the verification technique(s) can include computing a similarity between an embedding of a negation of the question and the response with embedding(s) generated based on the training data (e.g., the text data set(s) 402). Similar to the description above, any technically feasible similarity, such as Cosine similarity, can be computed.

In some embodiments, the verification technique(s) can include computing an entailment score based on the training data (e.g., the text data set(s) 402), the request, and the response. Textual entailment refers to a relationship between two text fragments indicating whether the truth of one text fragment can be inferred from the other text fragment. Two text fragments can support (i.e., entail) each other, contradict each other, or be neutral. A value can be assigned to indicate the extent of the relationship between two text fragments, which is referred to herein as the entailment score. In some embodiments, a trained textual entailment model can be used to compute an entailment score between training data (e.g., the text data set(s) 402) and a combination of the request and the response. In some other embodiments, the verification technique(s) can include computing an entailment score using the (e.g., the text data set(s) 402) training data and only the response generated by the language model 150.

In some embodiments, the verification technique(s) can include asking another model to verify the response. In such cases, the other model that is asked to verify the response can take as input an output of the language model 150 and output one or more associated contexts and/or a truth, probability, etc. of the output of the language model 150 with respect to one or more contexts. For example, in some embodiments, the other model can be another language model, such as an LLM, that is trained on a vocabulary of contexts. As another example, in some embodiments, the other model can include a set of rules.

In some embodiments, when the verification module 506 performs multiple verification techniques, the verification module 506 can determine final verification information in any technically feasible manner. For example, in some embodiments, the verification module 506 can verify a response generated by the language model 150 only when a majority of the verification techniques indicate that the response is verified. As another example, in some embodiments, the verification module 506 can compute a weighted sum of scores generated by multiple verification techniques. After computing final verification information for the response with optional context information 504 that is generated by the language model 150, the response verification module 506 outputs the response with the optional context information and the verification information 508. For example, the response verification module could append, to the end of the response and the optional context information 504, the verification information. Alternatively, in some embodiments, the verification information can be output separately from the response and the optional context information 504. The response with the optional context information and the verification information 508 can then be displayed to a user in any technically feasible manner, such as via a user interface.

FIG. 6 is a flow diagram of method steps for training a language model, according to various embodiments. Although the method steps are described in conjunction with FIG. 1-5, persons skilled in the art will understand that any system configured to perform the method steps, in any order, falls within the scope of the present disclosure.

As shown, a method 600 begins at step 602, where the model trainer 116 receives one or more text data sets. Any suitable text data set(s), such as the common crawl, books, newspapers, journal articles, code libraries, and/or the like can be received in some embodiments.

At step 604, the model trainer 116 appends context information to portions of text data set(s). In some embodiments, the context information that is appended to each portion of the text data set(s) can include one or more tokens indicating one or more contexts associated with the portion. In some embodiments, the context information that is appended to each portion of the text data set(s) can include an indication of a hierarchy of contexts associated with the portion. In some embodiments, context information can be appended at any location within the portions of the text data set(s), such as at the end of the portions.

At step 606, the model trainer 116 trains a language model using the text data set(s) with appended context information. For example, in some embodiments, the model trainer 116 can train the language model to reproduce each portion of the text data set(s) with appended context information, such as each sentence that ends with a token indicating an associated context or a hierarchy of associated contexts, on a token-by-token basis, until the language model 150 is able to reproduce the portion of the text data set(s) and the associated context or hierarchy of associated contexts, and the training then proceeds to a next portion of the text data set(s) with appended context information.

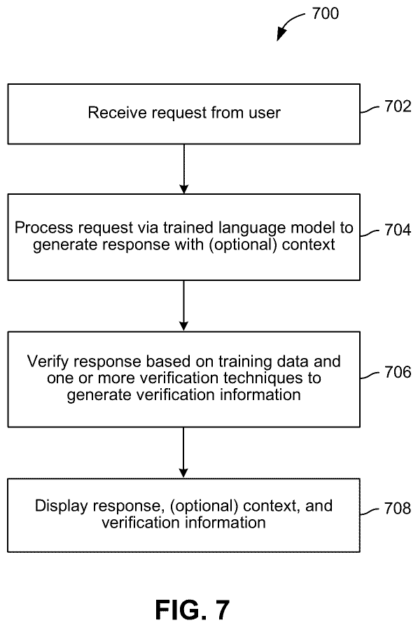

FIG. 7 is a flow diagram of method steps for processing a user request using a trained language model, according to various embodiments. Although the method steps are described in conjunction with FIG. 1-5, persons skilled in the art will understand that any system configured to perform the method steps, in any order, falls within the scope of the present disclosure.

As shown, a method 600 begins at step 702, where the natural language application 146 receives a request from a user. In some embodiments, the request can include any suitable text data (e.g., a question) that can be processed using the trained language model 150.

At step 704, the natural language application 146 processes the request via the trained language model 150 to generate a response with optionally a context associated with the response. Once trained, the language model 150 is capable of responding to user requests and also providing the context associated with each response. For example, in some embodiments, the language model 150 can append a token indicating the context to the end of a response if the language model 150 is trained using sentences that end with tokens indicating the context associated with the sentences. As another example, in some embodiments, the language model 150 can append a hierarchy of contexts associated with a response to the end of the response if the language model 150 is trained using sentences that end with hierarchies of associated contexts. However, in some other embodiments, a language model may not be trained to output a context associated with a response.

At step 706, the natural language application 146 verifies the response based on training data using to train the language model 150 and one or more verification techniques to generate verification information. In some embodiments, the verification techniques can include comparing an embedding of the response with embedding(s) generated based on the training data; comparing an embedding of a negation of the question and the response with embedding(s) generated based on the training data; computing an entailment score based on the training data, the request, and the response; computing an entailment score using the training and only the response; and/or asking another model to verify the response, as described above in conjunction with FIG. 5. In some embodiments, when the natural language application 146 performs multiple verification techniques, the natural language application 146 can determine final verification information in any technically feasible manner, such as by verifying the response only if a majority of the verification techniques indicate that the response is verified, by computing a weighted sum of scores generated by the multiple verification techniques, and/or the like.

At step 706, the natural language application 146 causes the response from the language model 150, the (optional) context, and the verification information to be displayed to a user. The response, (optional) context, and verification information can be displayed in any technically feasible manner, such as via a user interface, in some embodiments.

In sum, techniques are disclosed for training and using context-aware language models. In some embodiments, a model trainer appends context information to one or more portions of text data to generate training data for training a language model. The context information that is appended to each portion of text data can include a token indicating one or more contexts associated with the portion of text data, or a hierarchy of one or more contexts associated with the portion of text data. Using the generated training data, the model trainer can train a language model to generate, in response to a user request, a response as well as context information associated with the response. In addition, responses generated by a trained language model can be verified against training data used to train the language model to determine whether the responses are supported by the training data or not.

One technical advantage of the disclosed techniques relative to the prior art is that the disclosed techniques train machine learning models to learn the context(s) associated with training data, such as text data that is used to train language models. Once trained, the machine learning models can output not only a response to a given request, but also the context associated with that response. Another advantage is that, with the disclosed techniques, responses generated by a machine learning model can be verified against data used to train the machine learning model. These technical advantages provide one or more technological improvements over prior art approaches.

1. In some embodiments, a computer-implemented method for training a machine learning model comprises appending context information to at least one portion of first data to generate second data, and performing one or more operations to train the machine learning model based on the second data to generate a trained machine learning model.

2. The computer-implemented method of clause 1, wherein the context information appended to each portion included in the at least one portion comprises a token indicating one or more contexts associated with the portion.

3. The computer-implemented method of clauses 1 or 2, wherein the context information appended to each portion included in the at least one portion indicates a hierarchy of one or more contexts associated with the portion.

4. The computer-implemented method of any of clauses 1-3, wherein the context information appended to each portion included in the at least one portion indicates at least one data source from which the portion originates.

5. The computer-implemented method of any of clauses 1-4, further comprising processing a request via the trained machine learning model to generate a response and context information associated with the response.

6. The computer-implemented method of any of clauses 1-5, wherein the context information is appended to an end of each portion included in the at least one portion of first data.

7. The computer-implemented method of any of clauses 1-6, further comprising processing a first request via the trained machine learning model to generate a first response, and performing one or more operations to verify the first response based on the first data.

8. The computer-implemented method of any of clauses 1-7, wherein performing the one or more operations to verify the first response comprises generating a first embedding based on the first response, generating a second embedding based on the first data, and computing a similarity between the first embedding and the second embedding.

9. The computer-implemented method of any of clauses 1-8, wherein performing the one or more operations to verify the first response comprises computing an entailment score based on the first data and at least one of the first request or the first response.

10. The computer-implemented method of any of clauses 1-9, wherein performing the one or more operations to verify the first response comprises processing the first response via another trained machine learning model to generate a second response that indicates whether the first response is verified.

11. In some embodiments, one or more non-transitory computer readable media include instructions that, when executed by one or more processors, cause the one or more processors to perform the steps of appending context information to at least one portion of first data to generate second data, and performing one or more operations to train the machine learning model based on the second data to generate a trained machine learning model.

12. The one or more non-transitory computer readable media of clause 11, wherein the context information that is appended to each portion included in the at least one portion comprises a token indicating one or more contexts associated with the portion.

13. The one or more non-transitory computer readable media of clauses 11 or 12, wherein the context information that is appended to each portion included in the at least one portion indicates a hierarchy of one or more contexts associated with the portion.

14. The one or more non-transitory computer readable media of any of clauses 11-13, wherein the hierarchy of one or more contexts includes at least one of a book context, a volume context, a newspaper context, a journal context, an article context, or a code library context.

15. The one or more non-transitory computer readable media of any of clauses 11-14, wherein the first data comprises text data, and each portion included in the at least one portion comprises a sentence within the text data.

16. The one or more non-transitory computer readable media of any of clauses 11-15, wherein the instructions, when executed by the one or more processors, further cause the one or more processors to perform the step of processing a request via the trained machine learning model to generate a response and context information associated with the response.

17. The one or more non-transitory computer readable media of any of clauses 11-16, wherein the instructions, when executed by the one or more processors, further cause the one or more processors to perform the steps of processing a request via the trained machine learning model to generate a response, and performing one or more operations to verify the response based on the first data.

18. The one or more non-transitory computer readable media of any of clauses 11-17, wherein the trained machine learning model comprises a language model.

19. The one or more non-transitory computer readable media of any of clauses 11-18, wherein performing the one or more operations to train the machine learning model comprises training the machine learning model to regenerate at least one portion of the second data on a token-by-token basis.

20. In some embodiments, a system comprises one or more memories storing instructions, and one or more processors coupled to the one or more memories that, when executing the instructions, perform the steps of appending context information to at least one portion of first data to generate second data, and performing one or more operations to train the machine learning model based on the second data to generate a trained machine learning model.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

One technical advantage of the disclosed techniques relative to the prior art is that the disclosed techniques train machine learning models to learn the context(s) associated with training data, such as text data that is used to train language models. Once trained, the machine learning models can output the context associated with a response that is generated in response to a request. Another advantage is that, with the disclosed techniques, responses generated by a machine learning model can be verified against source data used to train the machine learning model. These technical advantages provide one or more technological improvements over prior art approaches.

What is claimed is:

1. A computer-implemented method for training a machine learning model, the method comprising:
appending context information to at least one portion of first data to generate second data; and
performing one or more operations to train the machine learning model based on the second data to generate a trained machine learning model.

2. The computer-implemented method of claim 1, wherein the context information appended to each portion included in the at least one portion comprises a token indicating one or more contexts associated with the portion.

3. The computer-implemented method of claim 1, wherein the context information appended to each portion included in the at least one portion indicates a hierarchy of one or more contexts associated with the portion.

4. The computer-implemented method of claim 1, wherein the context information appended to each portion included in the at least one portion indicates at least one data source from which the portion originates.

5. The computer-implemented method of claim 1, further comprising processing a request via the trained machine learning model to generate a response and context information associated with the response.

6. The computer-implemented method of claim 1, wherein the context information is appended to an end of each portion included in the at least one portion of first data.

7. The computer-implemented method of claim 1, further comprising:
processing a first request via the trained machine learning model to generate a first response; and
performing one or more operations to verify the first response based on the first data.

8. The computer-implemented method of claim 7, wherein performing the one or more operations to verify the first response comprises:
generating a first embedding based on the first response;
generating a second embedding based on the first data; and
computing a similarity between the first embedding and the second embedding.

9. The computer-implemented method of claim 7, wherein performing the one or more operations to verify the first response comprises computing an entailment score based on the first data and at least one of the first request or the first response.

10. The computer-implemented method of claim 7, wherein performing the one or more operations to verify the first response comprises:
processing the first response via another trained machine learning model to generate a second response that indicates whether the first response is verified.

11. One or more non-transitory computer readable media including instructions that, when executed by one or more processors, cause the one or more processors to perform the steps of:
appending context information to at least one portion of first data to generate second data; and
performing one or more operations to train the machine learning model based on the second data to generate a trained machine learning model.

12. The one or more non-transitory computer readable media of claim 11, wherein the context information that is appended to each portion included in the at least one portion comprises a token indicating one or more contexts associated with the portion.

13. The one or more non-transitory computer readable media of claim 11, wherein the context information that is appended to each portion included in the at least one portion indicates a hierarchy of one or more contexts associated with the portion.

14. The one or more non-transitory computer readable media of claim 11, wherein the hierarchy of one or more contexts includes at least one of a book context, a volume context, a newspaper context, a journal context, an article context, or a code library context.

15. The one or more non-transitory computer readable media of claim 11, wherein the first data comprises text data, and each portion included in the at least one portion comprises a sentence within the text data.

16. The one or more non-transitory computer readable media of claim 11, wherein the instructions, when executed by the one or more processors, further cause the one or more processors to perform the step of processing a request via the trained machine learning model to generate a response and context information associated with the response.

17. The one or more non-transitory computer readable media of claim 11, wherein the instructions, when executed by the one or more processors, further cause the one or more processors to perform the steps of:
processing a request via the trained machine learning model to generate a response; and
performing one or more operations to verify the response based on the first data.

18. The one or more non-transitory computer readable media of claim 11, wherein the trained machine learning model comprises a language model.

19. The one or more non-transitory computer readable media of claim 11, wherein performing the one or more operations to train the machine learning model comprises training the machine learning model to regenerate at least one portion of the second data on a token-by-token basis.

20. A system comprising:
one or more memories storing instructions; and
one or more processors coupled to the one or more memories that, when executing the instructions, perform the steps of:
appending context information to at least one portion of first data to generate second data, and
performing one or more operations to train the machine learning model based on the second data to generate a trained machine learning model.
